(19) United States
(12) Patent Application Publication
(10) Pub. No.: US 2019/0006076 A1
(43) Pub. Date: Jan. 3, 2019

(54) INDUCTOR MODULE

(71) Applicant: Murata Manufacturing Co., Ltd., Nagaokakyo-shi (JP)

(72) Inventor: Hirokazu YAZAKI, Nagaokakyo-shi (JP)

(21) Appl. No.: 16/127,276

(22) Filed: Sep. 11, 2018

Related U.S. Application Data
(63) Continuation of application No. PCT/JP2017/014955, filed on Apr. 12, 2017.

(30) Foreign Application Priority Data
Apr. 13, 2016 (JP) 2016-080685

(51) Int. Cl. H01F 17/00; H01F 17/04; H01F 27/29; H01F 37/00; H02M 3/155; H04B 5/02; H01F 41/04

(52) U.S. Cl. CPC H01F 17/0013; H01F 17/04; H01F 27/29; H01F 41/046; H02M 3/155; H04B 5/02; H01F 37/00

(57) ABSTRACT

An inductor module includes an insulating flexible substrate including a thermoplastic resin, an IC element included in the flexible substrate, chip capacitors included in the flexible substrate, a chip inductor that includes a magnetic-material body and is located on a first main surface of the flexible substrate, and input and output terminals on a second main surface of the flexible substrate. The IC element may be a switching IC element, the chip inductor may be a choke coil, and the inductor module may be a DC/DC converter module.

### CROSS REFERENCE TO RELATED APPLICATIONS

This application claims the benefit of priority to Japanese Patent Application No. 2016-080685 filed on Apr. 13, 2016 and is a Continuation Application of PCT Application No. PCT/JP2017/014955 filed on Apr. 12, 2017. The entire contents of each application are hereby incorporated herein by reference.

### BACKGROUND OF THE INVENTION

### 1. Field of the Invention

The present invention relates to an inductor module, and particularly, to an inductor module including a choke coil that is defined by a chip inductor.

### 2. Description of the Related Art

It has been known that an inductor module includes a choke coil that is formed of a chip inductor. An example of such an inductor module is disclosed in Japanese Unexamined Patent Application Publication No. 2011-205853 and Japanese Unexamined Patent Application Publication No. 2011-138812, for example, which disclose a DC/DC converter module in which a chip inductor as a choke coil and a chip capacitor for smoothing are mounted by surface mounting on a substrate that includes a switching IC element.

However, the inventor of preferred embodiments of the present invention has discovered that there are factors that decrease the mechanical strength of an existing inductor module and hinder a decrease in size of the module.

### SUMMARY OF THE INVENTION

Preferred embodiments of the present invention provide inductor modules that each have a high mechanical strength and a decreased size.

An inductor module according to a preferred embodiment of the present invention includes an insulating flexible substrate including a thermoplastic resin, an IC element that is included in the flexible substrate, a chip capacitor that is included in the flexible substrate, a chip inductor that includes a magnetic-material body and that is mounted on a first main surface of the flexible substrate, and input and output terminals that are provided on a second main surface of the flexible substrate.

With this structure, since the flexible substrate includes a thermoplastic resin, that is, the substrate has shock absorption properties, the IC element is unlikely to directly take an impact, such as a falling impact, and impact resistance is increased.

In the inductor module, the IC element may be disposed within a projection area of the chip inductor in a plan view.

With this structure, the other components are prevented from being affected by a noise that is made by the IC element.

The chip inductor may include a planar electrode on a main surface thereof that faces the flexible substrate and may be connected to the flexible substrate with the planar electrode interposed therebetween.

With this structure, the chip inductor is able to be mounted with a larger area than, for example, in the case in which a chip inductor that includes an electrode on an edge surface is used. This facilitates high current of the chip inductor and improvements in direct current superposition characteristics thereof. In addition, a structure that decreases a noise that is made by the IC element is readily provided in the chip inductor.

The IC element may be disposed so as not to overlap the input and output terminals in a plan view.

With this structure, the IC element avoids being disposed at a location of the flexible substrate at which the shock absorption properties are decreased due to the input and output terminals, and impact resistance against, for example, falling is further improved.

Portions of wiring lines that connect the IC element and the input and output terminals to each other may extend to an inside of the body of the chip inductor.

With this structure, the inductance of the portion of each wiring line due to the magnetic-material body enables a radio frequency noise that is superposed on the wiring line to be decreased.

The body of the chip inductor may be made of magnetic ceramics.

With this structure, the size and height of the chip inductor are decreased because of high magnetic permeability of the magnetic ceramics.

The body of the chip inductor and the flexible substrate may be directly joined to each other.

With this structure, in which the body of the chip inductor and the flexible substrate are directly joined to each other, a mechanical strength is higher than that in the case in which the chip inductor and the flexible substrate are connected using only the planar electrode. There is no space between the chip inductor and the flexible substrate, and accordingly, undesired electromagnetic waves, which may be emitted when there is a space therebetween, are reduced.

An auxiliary layer may be disposed on another main surface of the chip inductor opposite to the flexible substrate.

With this structure, the other main surface of the chip inductor is protected by the auxiliary layer, and the smoothness of the other main surface is improved. In the case in which the auxiliary layer is made of the same material as the flexible substrate, the coefficient of thermal shrinkage of both main surfaces of the inductor module is balanced, and the inductor module reduced or prevented from warping and bending in a heat treatment during manufacturing.

The chip inductor and the flexible substrate may have the same or substantially the same size in a plan view.

With this structure, the magnetic-material body of the chip inductor is able to be mounted with the largest area. This facilitates high current of the chip inductor and improvements in direct current superposition characteristics thereof. In addition, a structure that decreases a noise that is made by the IC element is readily provided in the chip inductor.

The IC element may be a switching IC element, the chip inductor may be a choke coil, and the inductor module may be a DC/DC converter module.

With this structure, the inductor module enables a DC/DC converter module that has high impact resistance to be obtained.

The IC element may be a RFIC element, the chip inductor may be an antenna coil, and the inductor module may define a RF module.

With this structure, the inductor module enables a RF module that has high impact resistance to be obtained.

In inductor modules according to preferred embodiments of the present invention, since the flexible substrate includes a thermoplastic resin, that is, the substrate has shock absorption properties, the IC element is unlikely to directly take an impact, such as a falling impact, and the impact resistance is increased.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view of an example of the structure of a DC/DC converter module according to a first preferred embodiment of the present invention.

FIG. 2 is a sectional view of an example of the structure of the DC/DC converter module according to the first preferred embodiment of the present invention.

FIG. 3 is a circuit diagram of an example of a DC/DC converter circuit according to the first preferred embodiment of the present invention.

FIG. 4 is a sectional view of an example of the structure of a DC/DC converter module according to a second preferred embodiment of the present invention.

FIG. 5 illustrates an example of a process of manufacturing the DC/DC converter module according to the second preferred embodiment of the present invention with a sectional view.

FIG. 6 illustrates an example of a process of manufacturing the DC/DC converter module according to the second preferred embodiment of the present invention with a sectional view.

FIGS. 7A to 7C illustrate an example of a process of manufacturing the DC/DC converter module according to the second preferred embodiment of the present invention.

FIGS. 8A and 8B illustrate schematic enlarged views of main portions of the DC/DC converter module according to the second preferred embodiment of the present invention before and after the portions are integrally formed.

FIG. 9 is a sectional view of an example of the structure of a DC/DC converter module according to a third preferred embodiment of the present invention.

FIG. 10 is a circuit diagram of an example of a DC/DC converter circuit according to the third preferred embodiment of the present invention.

FIG. 11 is an exploded perspective view of an example of the structure of a RF module according to a fourth preferred embodiment of the present invention.

FIG. 12 is a circuit diagram of an example of a RF circuit according to the fourth preferred embodiment of the present invention.

FIG. 13 is a sectional view of an example of a structure in which the RF module according to the fourth preferred embodiment of the present invention is mounted.

### DETAILED DESCRIPTION OF THE PREFERRED EMBODIMENTS

Preferred embodiments of the present invention will hereinafter be described in detail with reference to the drawings. The preferred embodiments described below are comprehensive or specific examples. In the following description according to the preferred embodiments, numerical values, shapes, materials, components, and the arrangement and connection structure of the components are described by way of example and do not limit the present invention. Among the components according to the preferred embodiments below, components that are not recited in the independent claim are described as optional components. The size of each component illustrated in the drawings or the ratio of the size is not necessarily illustrated strictly.

### First Preferred Embodiment

An inductor module according to a first preferred embodiment of the present invention includes a chip inductor that is mounted on an insulating flexible substrate that includes an IC element and a chip capacitor and that includes a thermoplastic resin.

The inductor module according to the first preferred embodiment will now be described with a specific example in which the IC element is a switching IC element, the chip inductor is a choke coil, and the inductor module defines a DC/DC converter module

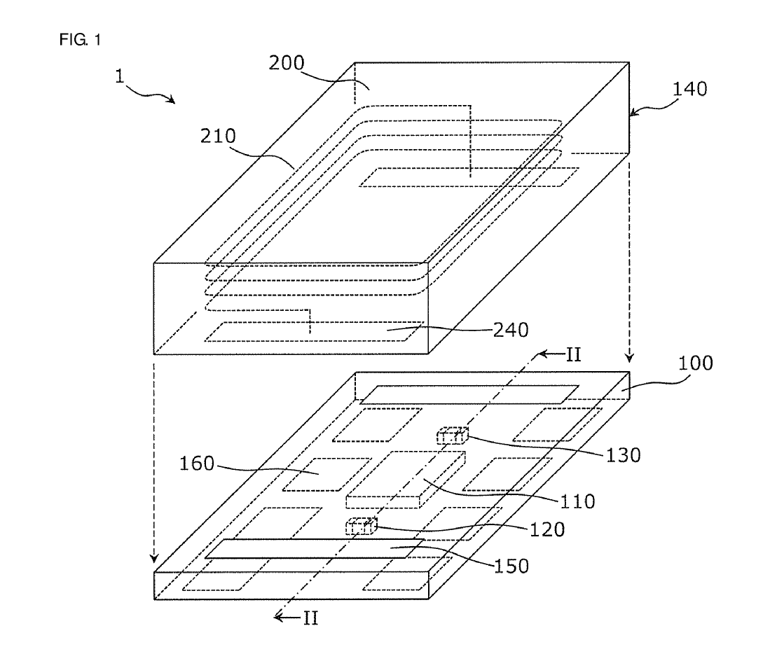

FIG. 1 is an exploded perspective view of an example of the structure of the DC/DC converter module according to the first preferred embodiment. As illustrated in FIG. 1, the DC/DC converter module 1 includes a flexible substrate 100, a switching IC element 110, chip capacitors 120 and 130, a chip inductor 140, and input and output terminals 160. The flexible substrate 100 and the chip inductor 140 are connected to each other at connection terminals 150 and 240.

The flexible substrate 100 is an insulating substrate that preferably includes a thermoplastic resin, for example. The switching IC element 110 and the chip capacitors 120 and 130 are included in the flexible substrate 100.

The chip inductor 140 includes a coil 210 that is disposed in a magnetic-material body 200 and is mounted on one main surface of the flexible substrate 100.

The input and output terminals 160 are terminals to mount the DC/DC converter module 1 on a motherboard, such as a printed circuit board, and are provided on the other main surface of the flexible substrate 100. In the flexible substrate 100, the switching IC element 110 is disposed so as not to overlap the input and output terminals 160 in a plan view, and the connection terminals 150 are disposed so as to overlap the input and output terminals 160 in a plan view.

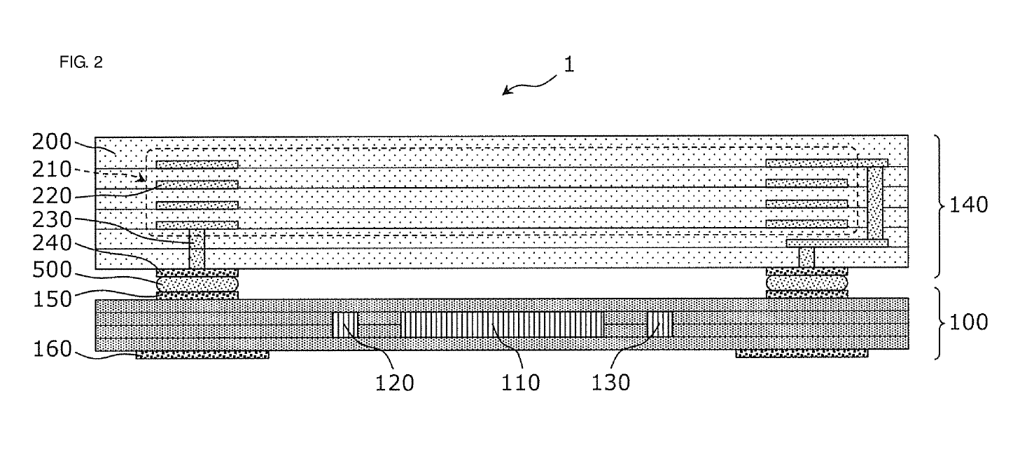

FIG. 2 is a sectional view of an example of the structure of the DC/DC converter module 1 when a section II-II in FIG. 1 is viewed from the direction of arrows. In the following description, for simplicity, the same or similar components are represented by the same or similar patterns, and reference numbers thereof are appropriately omitted. In some cases, components that are located on different sections in a strict sense are illustrated in the same drawing.

As illustrated in FIG. 2, the body 200 of the chip inductor 140 is a magnetic material substrate that includes magnetic-material layers that are stacked. The body 200 includes coil conductors defining the coil 210. The coil conductors include in-plane conductors 220 that loop along main surfaces of the magnetic-material layers and interlayer conductors 230 that extend in the thickness direction of the magnetic-material layers. The in-plane conductors 220 that are adjacent to each other in the stacking direction are connected to each other by the interlayer conductors (not illustrated in FIG. 2) to define the coil 210. The coil 210 is connected to the connection terminals 240 with the interlayer conductors 230 interposed therebetween. The connection terminals 240 are LGA (Land Grid Array) planar electrodes.

The body 200 may be made of magnetic ceramics or may be formed of a metal composite. Specifically, the body 200 may preferably be made of ferrite-based magnetic ceramics, for example.

The in-plane conductors 220, the interlayer conductors 230, and the connection terminals 240 may preferably be made of a metal, a main component of which is silver or an alloy thereof, for example. The connection terminals 240 may preferably be plated with, for example, nickel, palladium, or gold.

The chip inductor 140 is manufactured, for example, in a manner in which a conductive paste is applied to magnetic ceramic green sheets at positions at which the coil conductors are to be formed, the magnetic ceramic green sheets are stacked into an integrally formed green block, and the green block is collectively fired. That is, the chip inductor 140 may preferably be a magnetic ceramic chip that is obtained by co-firing a ferrite sintered body that defines the body 200 with a metal that defines the coil 210. The conductive paste may be applied to the ceramic green sheets at desired positions by screen printing.

Magnetic or non-magnetic ferrite ceramics that defines the body 200 may preferably be LTCC ceramics (Low Temperature Co-fired Ceramics), for example, that have been fired at a firing temperature equal to or less than the melting point of silver. In this case, the in-plane conductors 220 and the interlayer conductors 230 may preferably be made of silver, for example.

The in-plane conductors 220 and the interlayer conductors 230 that are preferably made of silver, for example, which has low resistivity, enable a DC/DC converter to have good characteristics, for example, with a low loss and high power efficiency. In particular, the use of silver for the above conductor enables the chip inductor 140 to be fired in an oxidizing atmosphere, such as the air.

The flexible substrate 100 is a multilayer substrate that includes thermoplastic resin layers that are stacked. The switching IC element 110 and the chip capacitors 120 and 130 are embedded in the flexible substrate 100. Various wiring line conductors defining a DC/DC converter circuit are disposed although this is not illustrated. The wiring line conductors include the in-plane conductors that extend along the main surfaces of the thermoplastic resin layers and the interlayer conductors that extend in the thickness direction of the thermoplastic resin layers. The connection terminals 150 and the input and output terminals 160 are connected to corresponding nodes of the DC/DC converter circuit with the wiring line conductors interposed therebetween. The connection terminals 150 and the input and output terminals 160 are preferably LGA planar electrodes, for example.

The thermoplastic resin layers of the flexible substrate 100 may preferably include an insulating thermoplastic resin, such as polyimide or a liquid-crystal polymer, for example. The interlayer conductors may be made of a metal, a main component of which is tin or an alloy thereof. The in-plane conductors, the connection terminals 150, and the input and output terminals 160 may be made of a metal, a main component of which is copper or an alloy thereof.

The flexible substrate 100 is manufactured, for example, in a manner in which the switching IC element 110 and the chip capacitors 120 and 130 are disposed in thermoplastic resin sheets, the thermoplastic resin sheets and conductor patterns, which are to be the wiring line conductors, the connection terminals 150, and the input and output terminals 160, are stacked, and a thermo-compression bonding process is performed thereon.

The conductor patterns may be obtained by etching copper foils or copper alloy foils that are disposed on the thermoplastic resin sheets into the shapes of the in-plane conductors, the connection terminals 150, and the input and output terminals 160. Cavities to accommodate the switching IC element 110 and the chip capacitors 120 and 130 are formed in the corresponding thermoplastic resin sheets by, for example, a presswork process or a laser process in advance. The switching IC element 110 and the chip capacitors 120 and 130 may be completely embedded in the flexible substrate 100 or may be partially embedded therein.

The connection terminals 150 and 240 are connected to each other with a conductive joining material 500, such as tin-based solder, for example, to integrally form the flexible substrate 100 and the chip inductor 140 into the DC/DC converter module 1.

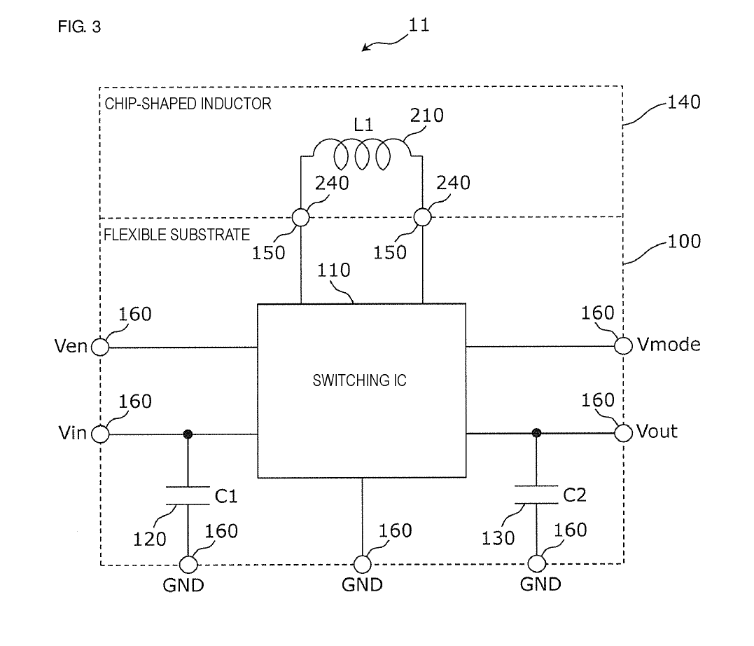

FIG. 3 is a circuit diagram of an example of the DC/DC converter circuit that is provided in the DC/DC converter module 1.

A DC/DC converter circuit 11 illustrated in FIG. 3 includes a switching IC, a choke coil L1, capacitors C1 and C2, and various input and output terminals. The input and output terminals include an enable terminal Ven, a control terminal Vcon, an input terminal Vin, an output terminal Vout, and three ground terminals GND.

The switching IC and the capacitors C1 and C2 are defined by the switching IC element 110 and the chip capacitors 120 and 130 that are included in the flexible substrate 100. The choke coil L1 is defined by the coil 210 that is included in the chip inductor 140. The enable terminal Ven, the control terminal Vcon, the input terminal Vin, the output terminal Vout, and the three ground terminals GND are defined by the corresponding input and output terminals 160 that are disposed on the flexible substrate 100.

The choke coil L1 is connected to the switching IC with the connection terminals 150 and 240 interposed therebetween. An end of the capacitor C1 is connected to an input voltage power line between the input terminal Vin and the switching IC. The other end of the capacitor C1 is connected to one of the ground terminals GND. An end of the capacitor C2 is connected to an output voltage power line between the switching IC and the output terminal Vout. The other end of the capacitor C2 is connected to another ground terminal GND.

The switching IC controls switching operation of the DC/DC converter circuit 11. A switching element, such as a MOS (Metal Oxide Semiconductor) FET (Field Effect Transistor), for example, is included inside the switching IC.

The DC/DC converter circuit 11 switches input voltage that is supplied to the input terminal Vin by using the switching element that is included in the switching IC, smooths the voltage using the choke coil L1 and the capacitor C2, and outputs the voltage to the output terminal Vout.

For example, the switching IC changes a pulse width while maintaining a constant switching frequency for PWM (Pulse Width Modulation) control to stabilize the output voltage that is to be output to the output terminal Vout at a target voltage. The switching IC may change the switching frequency while maintaining a constant pulse width for PFM (Pulse Frequency Modulation) control or may switch between the PWM control and the PFM control in accordance with a control signal that is sent to a mode terminal Vmode. The switching IC may start and stop the switching operation in accordance with a control signal that is sent to the enable terminal Ven.

The DC/DC converter circuit 11 is able to function as any one of a step-up DC/DC converter circuit, a step-down DC/DC converter circuit, and a step-up and step-down DC/DC converter circuit depending on whether the switching IC needs the step-up control, the step-down control, or the step-up and step-down control.

Specific examples of the DC/DC converter module 1 and the DC/DC converter circuit 11 are described above. The DC/DC converter module 1 achieves the following effects.

Since the flexible substrate 100 preferably includes a thermoplastic resin, for example, that is, the substrate has shock absorption properties, the switching IC element 110 is unlikely to directly take an impact, such as a falling impact, and the impact resistance is increased. Since the flexible substrate 100 includes the chip capacitors 120 and 130, that is, only the chip inductor 140 is mounted on a surface of the substrate, the size of the chip inductor 140 is able to be increased as much as possible with respect the area of the substrate. This enables large current to be achieved and direct current superposition characteristics to be improved. In the case in which the chip inductor 140 has a large area and a low height, the height of the DC/DC converter module 1 is decreased.

The body 200 of the chip inductor 140 is preferably made of a magnetic material, for example, and the switching IC element 110 is disposed within a projection area of the chip inductor 140 in a plan view. This enables the other components to be reduced or prevented from being affected by a noise that is made by the switching IC element 110.

The connection terminals 240 of the chip inductor 140 are preferably made of LGA planar electrodes, for example. This enables the chip inductor 140 to be mounted with a larger area than, for example, in the case in which a chip inductor that includes an electrode on an edge surface is used. This facilitates high current of the chip inductor 140 and improvements in direct current superposition characteristics thereof. In addition, a structure to decrease a noise that is made by the switching IC element 110 is readily provided in the chip inductor 140.

The switching IC element 110 is disposed so as not to overlap the input and output terminals 160 in a plan view. This avoids disposing the switching IC element 110 at a location of the flexible substrate 100 at which the shock absorption properties are decreased due to the input and output terminals 160, and further improves impact resistance against, for example, falling.

The connection terminals 150 are disposed at locations of the flexible substrate 100 at which the connection terminals 150 overlap the input and output terminals 160 in a plan view. An interlayer conductor may be disposed at one of locations at which the connection terminals 150 and the input and output terminals 160 overlap. This makes the stress that is applied to the input and output terminals 160 unlikely to be applied to the switching IC element 110 and further increases the mechanical strength of the DC/DC converter module 1.

The body 200 of the chip inductor 140 is preferably made of magnetic ceramics, for example. This enables the size and height of the chip inductor 140 to be decreased because of high magnetic permeability of the magnetic ceramics.

The chip inductor 140 and the flexible substrate 100 preferably have the same or substantially the same size in a plan view. This enables the body 200 of the chip inductor 140 to be mounted with the largest area and facilitates high current of the chip inductor 140 and improvements in direct current superposition characteristics thereof. In addition, a structure to decrease a noise that is made by the switching IC element 110 is readily provided in the chip inductor 140.

### Second Preferred Embodiment

In a DC/DC converter module according to a second preferred embodiment of the present invention, the flexible substrate and the chip inductor are directly and integrally joined to each other by a thermo-compression bonding process.

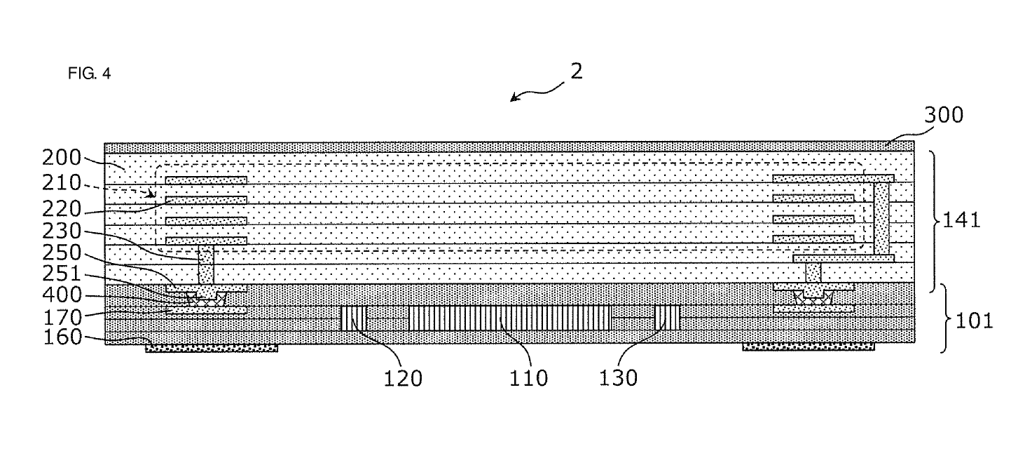

FIG. 4 is a sectional view of an example of the structure of a DC/DC converter module 2 according to the second preferred embodiment. The DC/DC converter module 2 differs from the DC/DC converter module 1 in FIG. 2 in that a flexible substrate 101 and a chip inductor 141 are modified and an auxiliary layer 300 is included. In the following description, components similar to those in the DC/DC converter module 1 are designated by the same reference numbers, a description thereof is omitted, and matters different from those described according to the first preferred embodiment will be described.

The flexible substrate 101 includes via conductors 400, instead of the connection terminals 150, and in-plane conductors 170 that are connected to the via conductors 400.

The chip inductor 141 includes connection terminals 250 instead of the connection terminals 240. Each connection terminal 250 includes a projection 251 that projects toward the flexible substrate 101.

The via conductors 400 and the connection terminals 250 may preferably be made of a metal, a main component of which is silver or an alloy thereof, for example.

The auxiliary layer 300 may preferably include an insulating thermoplastic resin, such as polyimide or a liquid-crystal polymer, for example, as in the flexible substrate 100.

The via conductors 400 and the connection terminals 250 are joined to each other, and the flexible substrate 101 and the body 200 of the chip inductor 141 are directly joined to each other. Thus, the flexible substrate 101 and the chip inductor 141 are integral in the DC/DC converter module 2.

A non-limiting example of a method of manufacturing the DC/DC converter module 2 will now be described.

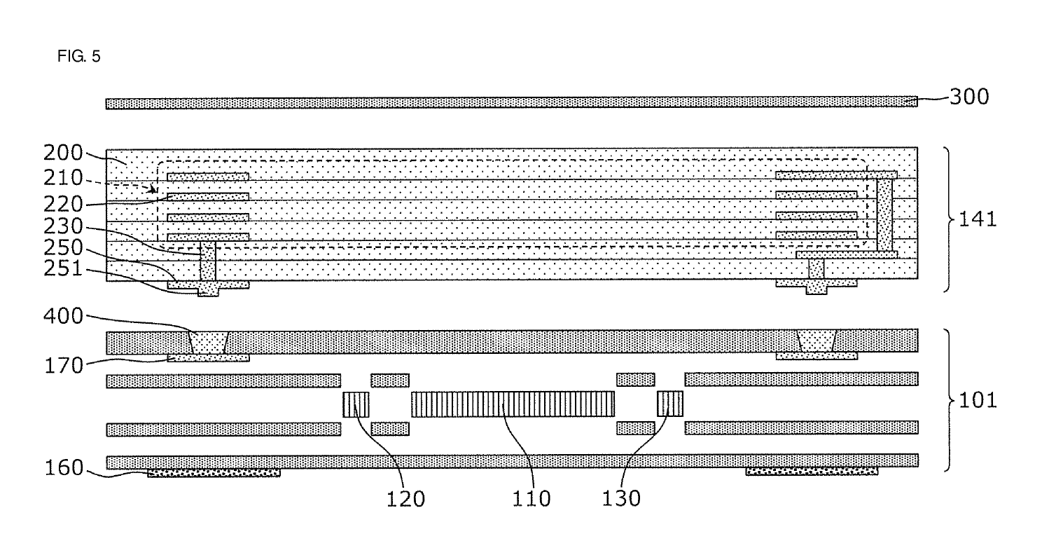

FIG. 5 and FIG. 6 illustrate a non-limiting example of a process of manufacturing the DC/DC converter module 2 with side views.

The chip inductor 141, thermoplastic resin sheets for the flexible substrate 101, and a thermoplastic resin sheet for the auxiliary layer 300 as illustrated in FIG. 5 are first prepared.

The chip inductor 141 may be manufactured in a manner in which a conductive paste is applied to magnetic ceramic green sheets, the magnetic ceramic green sheets are stacked into an integrally formed green block, and the green block is collectively fired as with the chip inductor 140. Also, the chip inductor 141 may be a magnetic ceramic chip that is obtained by co-firing a ferrite sintered body that forms the body 200 with a metal that forms the coil 210. The conductive paste may be applied to the ceramic green sheets at desired positions by screen printing. The projection 251 of each connection terminal 250 may be formed, for example, by applying layers of the conductive paste.

The thermoplastic resin sheets for the flexible substrate 101 and the thermoplastic resin sheet for the auxiliary layer 300 are preferably manufactured by molding a polyimide material or a liquid-crystal polymer material, for example, before thermal curing into sheets.

The conductor patterns, which are to be the wiring line conductors including the in-plane conductors 170 and the input and output terminals 160, are formed on the thermoplastic resin sheets for the flexible substrate 101. The cavities that accommodate the switching IC element 110, and the chip capacitors 120 and 130 and through-holes in which the via conductors 400 are disposed are formed.

The conductor patterns may be obtained by etching copper or silver alloy foils that are disposed on the thermoplastic resin sheets into the shapes of the wiring line conductors and the input and output terminals 160. The cavities and the through-holes may be formed by a presswork process or a laser process.

The through-holes are filled with the via conductors 400 that are uncured. The uncured via conductors 400 may be made of a conductive paste, a main component of which is, for example, silver and may be disposed in the through-holes by screen printing.

Subsequently, the thermoplastic resin sheets for the flexible substrate 101, the chip inductor 141, and the thermoplastic resin sheet for the auxiliary layer 300 are stacked in this order and positioned to form a multilayer block. The multilayer block is positioned between pressure bonding jigs 601 and 602 illustrated in FIG. 6, heated, and pressurized for the thermo-compression bonding process.

At this time, the resin of which the thermoplastic resin sheets are formed is softened once and fluidized. Consequently, the thermoplastic resin sheets are directly joined to each other, and the thermoplastic resin sheets and the body 200 of the chip inductor 141 (ferrite sintered body) are directly joined to each other. At the same time, the via conductors 400 (conductive paste) that are disposed in the corresponding thermoplastic resin sheet are metalized, and the via conductors 400 are electrically connected to the connection terminals 250 and the in-plane conductors 170.

Subsequently, the pressure bonding jigs 601 and 602 are detached, and the input and output terminals 160 that are exposed are plated. Specifically, nickel-gold plating films, for example, are preferably formed by electroless plating.

Through the above processes, the DC/DC converter module 2 is completed. The completed DC/DC converter module 2 is mounted on a motherboard, such as a printed circuit board, for example, with the input and output terminals 160 interposed therebetween.

An assembly of the DC/DC converter modules 2 may be manufactured in accordance with the above-described manufacturing method and may be separated into individual DC/DC converter modules 2.

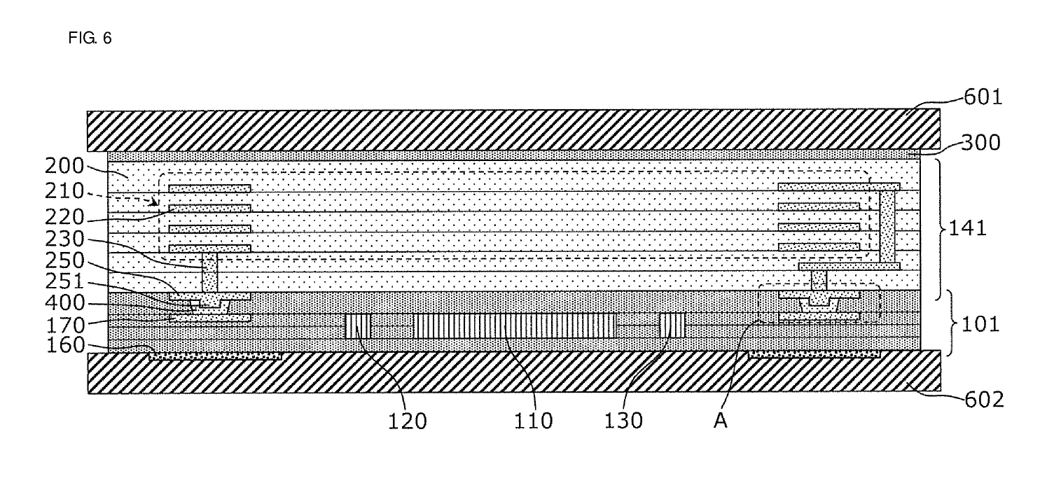

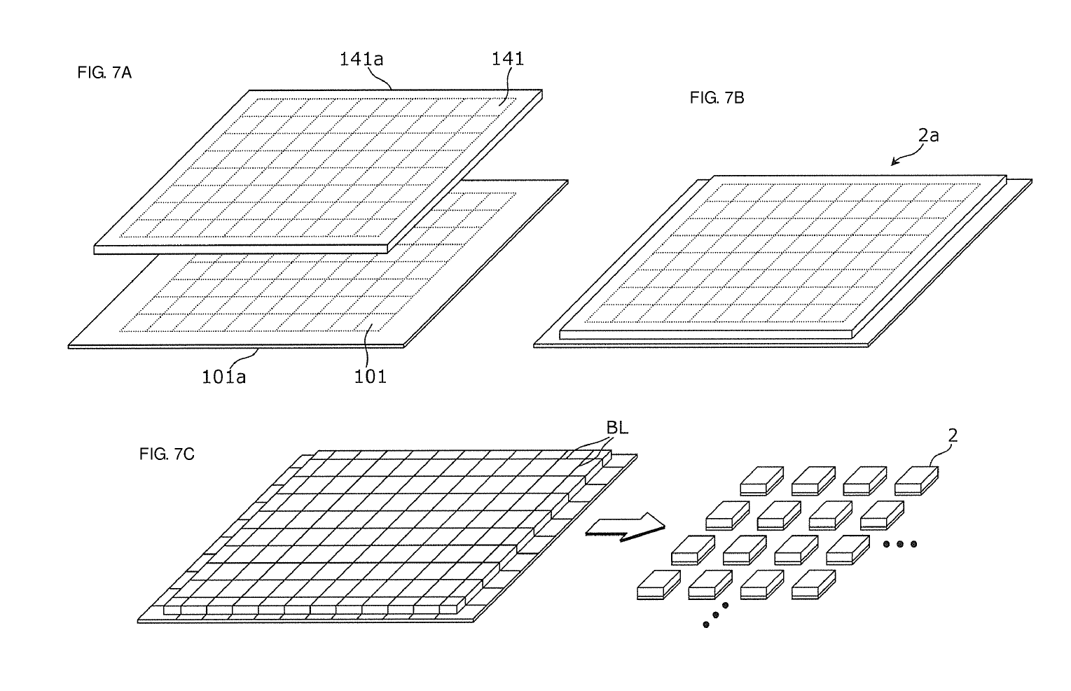

FIGS. 7A to 7C illustrate an example of a process of manufacturing the DC/DC converter modules 2 that includes a process of separating a collective board.

In the manufacturing process including the process of separating the collective board, as illustrated in FIG. 7A, an assembled inductor substrate 141a that corresponds to an assembly of the chip inductors 141 and an assembled flexible substrate 101a that corresponds to an assembly of the flexible substrates 101 are prepared. The assembled inductor substrate 141a includes two-dimensional arrays of the structure of the chip inductor 141 described with reference to FIG. 5. That is, in the assembled inductor substrate 141a, the chip inductors 141 are arranged in the longitudinal and lateral directions. The assembled flexible substrate 101a includes two-dimensional arrays of the structure of the flexible substrate 101 described with reference to FIG. 5, and the arrangement thereof corresponds to that of the chip inductors 141. That is, in the assembled flexible substrate 101a, the flexible substrates 101 are arranged in the longitudinal and lateral directions.

Subsequently, as illustrated in FIG. 7B, the assembled inductor substrate 141a and the assembled flexible substrate 101a are positioned to form an assembled multilayer block 2a. A thermoplastic resin sheet for the auxiliary layer 300, not illustrated, may be stacked on the assembled multilayer block 2a. The thermo-compression bonding process is performed on the assembled multilayer block 2a. Thus, as described with reference to FIG. 6, the chip inductors 141 and the flexible substrates 101 are mechanically joined and electrically connected to each other over the entire assembled multilayer block 2a at the same time.

Subsequently, as illustrated in FIG. 7C, the assembled multilayer block 2a is cut with, for example, a dicing saw along break lines BL that correspond to boundary lines of the adjoining DC/DC converter modules 2 and is separated into individual pieces. Thus, a large number of the DC/DC converter modules 2 are able to be obtained by a single separating process.

According to a process of manufacturing a typical DC/DC converter module, chip inductors are mounted on the assembled flexible substrate 101a one by one by using, for example, a mounter. In contrast, according to the above-described manufacturing method, a large number of the DC/DC converter modules 2 are able to be obtained by a single separating process from the assembled multilayer block 2a in which the assembled inductor substrate 141a and the flexible substrates 101 are integrally formed, and high productivity is achieved.

Each DC/DC converter module 2 has joint structures at portions A illustrated in FIG. 6.

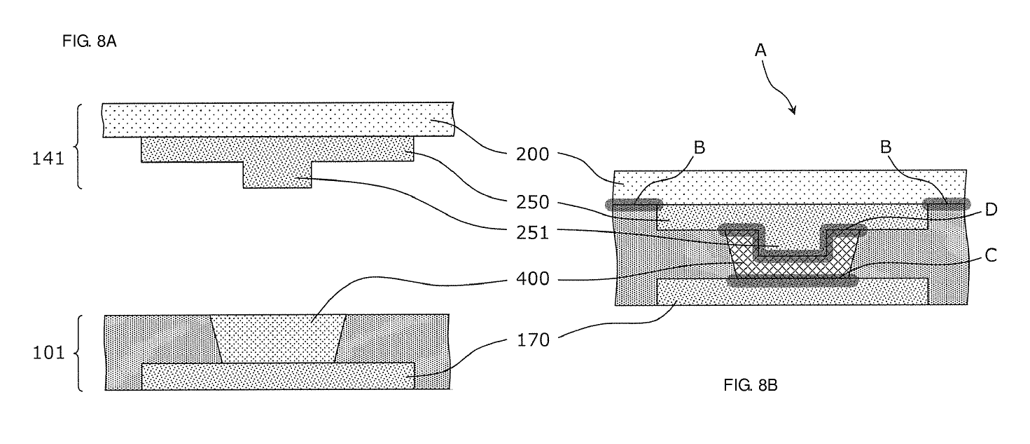

FIGS. 8A and 8B illustrate enlarged views of an example of the portions A of the DC/DC converter module 2. FIG. 8A schematically illustrates a state before the thermo-compression bonding process. FIG. 8B schematically illustrates a state after the thermo-compression bonding process.

In the thermo-compression bonding process, the resin of which the thermoplastic resin sheets for the flexible substrate 101 are formed catches on fine irregularities (porous structure) of a surface of the body 200 (ferrite sintered body) of the chip inductor 141 at portions B of the DC/DC converter module 2, and an anchor structure is formed. That is, the body 200 of the chip inductor 141 and the flexible substrate 101 are directly joined to each other. Thus, the flexible substrate 101 and the chip inductor 141 are securely mechanically joined to each other.

A similar anchor structure is formed between the thermoplastic resin sheet for the auxiliary layer 300 and the body 200 of the chip inductor 141 (not illustrated), and the auxiliary layer 300 and the chip inductor 141 are securely mechanically joined to each other.

In the thermo-compression bonding process, metalized silver is formed between the connection terminals 250 and the via conductors 400 at portions D of the DC/DC converter module 2, and an intermetallic compound of silver and copper is formed between the via conductors 400 and the in-plane conductors 170 at portions C. Thus, the connection terminals 250 and the via conductors 400 are securely mechanically and electrically joined to each other, and the via conductors 400 and the in-plane conductors 170 are securely mechanically and electrically joined to each other.

These joint structures enable the flexible substrate 101, the chip inductor 141, and the auxiliary layer 300 to be securely mechanically and electrically joined to each other. Consequently, the DC/DC converter module 2 has high mechanical strength (resistance against separation of different materials) and good electrical characteristics.

In the DC/DC converter module 2, there is no space between the chip inductor 141 and the flexible substrate 101, and accordingly, undesired electromagnetic waves, which may be emitted when there is a space therebetween, are reduced.

The DC/DC converter module 2 includes the auxiliary layer 300. Thus, the other main surface of the chip inductor 141 opposite to the flexible substrate 101 is protected, and the smoothness of the other main surface is improved. For example, the body 200 of the chip inductor 141, which is preferably a ferrite sintered body, for example, that is susceptible to a plating solution, is able to be protected by the auxiliary layer 300 from a plating solution when the input and output terminals 160 are plated.

In the case in which the auxiliary layer 300 is made of the same material as the flexible substrate, the coefficient of thermal shrinkage of both main surfaces of the DC/DC converter module 2 is balanced, and the DC/DC converter module 2 is prevented from warping and bending in the thermo-compression bonding process.

### Third Preferred Embodiment

In a DC/DC converter module described according to a third preferred embodiment of the present invention, the chip inductor includes an additional structure that decreases a noise that is made by the switching IC element.

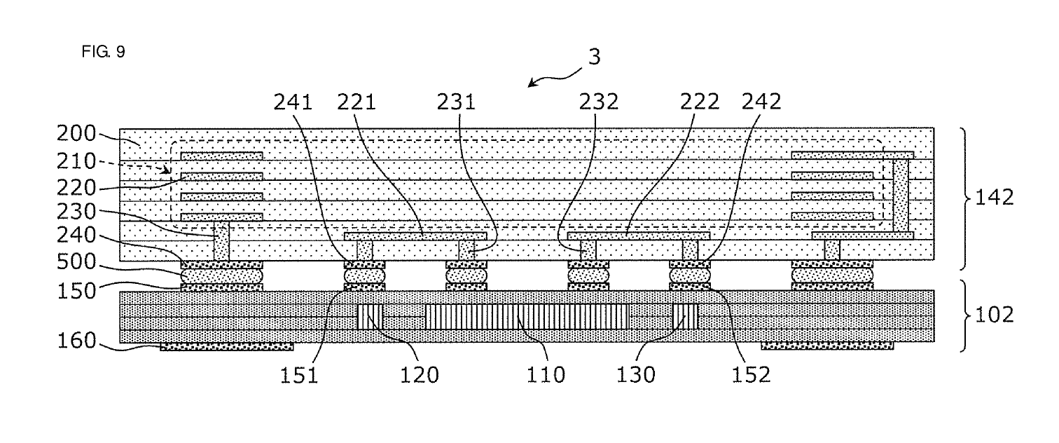

FIG. 9 is a sectional view of an example of the structure of a DC/DC converter module 3 according to the third preferred embodiment. The DC/DC converter module 3 differs from the DC/DC converter module 1 in FIG. 2 in that a flexible substrate 102 and a chip inductor 142 are modified. In the following description, components similar to those in the DC/DC converter module 1 are designated by the same reference numbers, a description thereof is omitted, and matters different from those described according to the first preferred embodiment will be described.

The flexible substrate 102 includes connection terminals 151 and 152 that are added to the flexible substrate 100 in FIG. 2. The connection terminals 151 and 152 are connected to corresponding nodes of a DC/DC converter circuit described below using connection wiring lines (not illustrated) in the flexible substrate 102.

The chip inductor 142 includes in-plane conductors 221 and 222, interlayer conductors 231 and 232, and connection terminals 241 and 242 added to the chip inductor 140 in FIG. 2.

The connection terminals 151 and the connection terminals 241 are connected to each other using the conductive joining material 500, such as tin-based solder, for example. The connection terminals 152 and the connection terminals 242 are connected to each other using the conductive joining material 500, such as tin-based solder, for example.

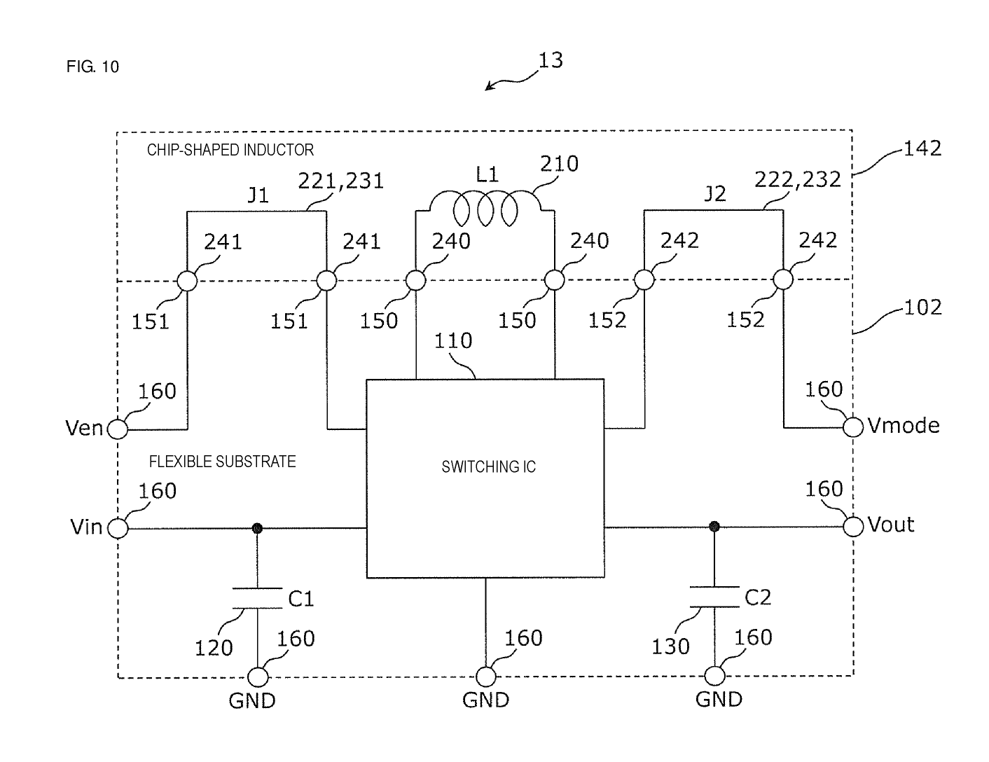

FIG. 10 is a circuit diagram of an example of the DC/DC converter circuit that is provided in the DC/DC converter module 3.

A DC/DC converter circuit 13 illustrated in FIG. 10 includes wiring lines J1 and J2 added to the DC/DC converter circuit 11 in FIG. 3.

The wiring line J1 is defined by the in-plane conductor 221 and the interlayer conductor 231 that are included in the chip inductor 142. The wiring line J2 is defined by the in-plane conductor 222 and the interlayer conductor 232 that are included in the chip inductor 142.

In the DC/DC converter circuit 13, a signal line between the enable terminal Ven and the switching IC and a signal line between the mode terminal Vmode and the switching IC extends to the inside of the chip inductor 142 via the wiring lines J1 and J2. That is, each signal line extends to the inside of the body 200 of the chip inductor 142 that is made of a magnetic material.

Thus, each signal line extends through a ferrite bead, and accordingly, a radio frequency noise that is superposed on a control signal that is transmitted through the signal line is able to be decreased. That is, the signal line is an example of the structure that decreases a noise that is made by the switching IC element 110.

### Fourth Preferred Embodiment

An inductor module according to a fourth preferred embodiment of the present invention includes a chip inductor that is mounted on an insulating flexible substrate that includes an IC element and a chip capacitor and that includes a thermoplastic resin as in the inductor module according to the first preferred embodiment.

The inductor module according to the fourth preferred embodiment will now be described with a specific example in which the IC element is a RFIC element, the chip inductor is an antenna coil, and the inductor module defines a RF module.

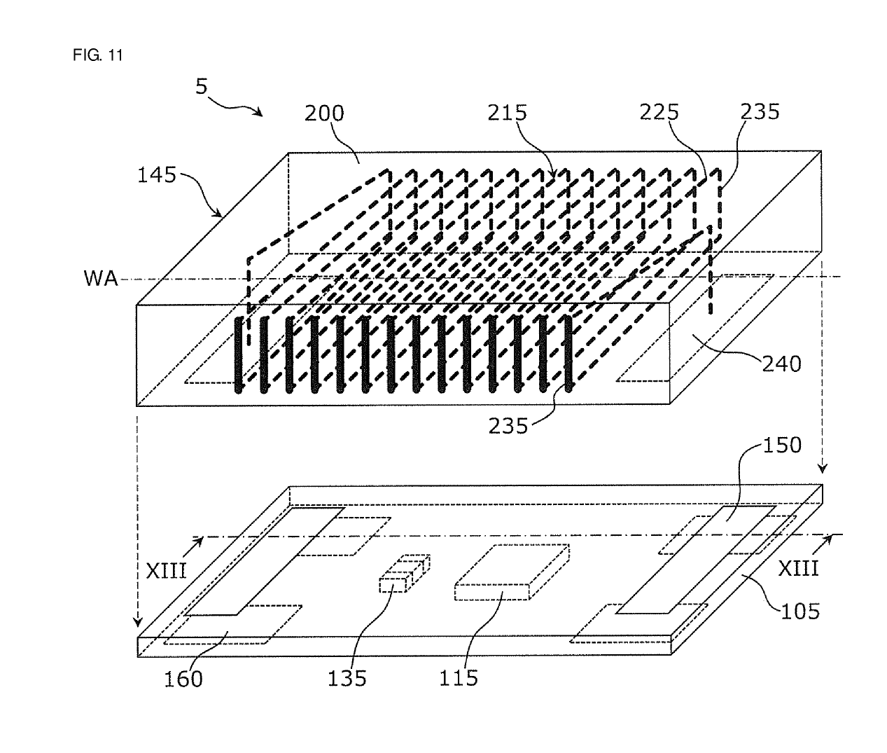

FIG. 11 is an exploded perspective view of an example of the structure of the RF module according to the fourth preferred embodiment. As illustrated in FIG. 11, a RF module 5 includes a flexible substrate 105, a RFIC element 115, a chip capacitor 135, a chip inductor 145, and the input and output terminals 160.

The flexible substrate 105 is an insulating substrate that preferably includes a thermoplastic resin, for example. The RFIC element 115 and the chip capacitor 135 are included in the flexible substrate 105.

The chip inductor 145 includes a coil 215 that is disposed in the body 200 that is made of a magnetic material and is mounted on one main surface of the flexible substrate 105. In the DC/DC converter modules 1 to 3, the coil 210 has a closed magnetic circuit structure that is suitable for a choke coil. The coil 215 of the RF module 5 has an open magnetic circuit structure that is suitable for an antenna coil.

The coil 215 may preferably be formed, for example, by spirally connecting interlayer conductors 235 that are exposed from side surfaces of the body 200 and in-plane conductors 225 that are disposed in the body 200 to each other but is not limited thereto. Ends of the coil 215 are connected to the connection terminals 240. The central axis WA of the coil 215 is parallel or substantially parallel to main surfaces of the RF module 5.

The input and output terminals 160 are provided to mount the RF module 5 on a motherboard, such as a printed circuit board, for example, and are provided on the other main surface of the flexible substrate 105. In the flexible substrate 105, the RFIC element 115 is disposed so as not to overlap the input and output terminals 160 in a plan view, and the connection terminals 150 are disposed so as to overlap the input and output terminals 160 in a plan view.

The flexible substrate 105 and the chip inductor 145 are connected to each other at the connection terminals 150 and 240. The flexible substrate 105 and the chip inductor 145 may be connected in a manner in which the connection terminals 150 and 240 are joined to each other using a conductive joining material as described according to the first preferred embodiment or may directly and integrally joined to each other by the thermo-compression bonding process as described according to the second preferred embodiment.

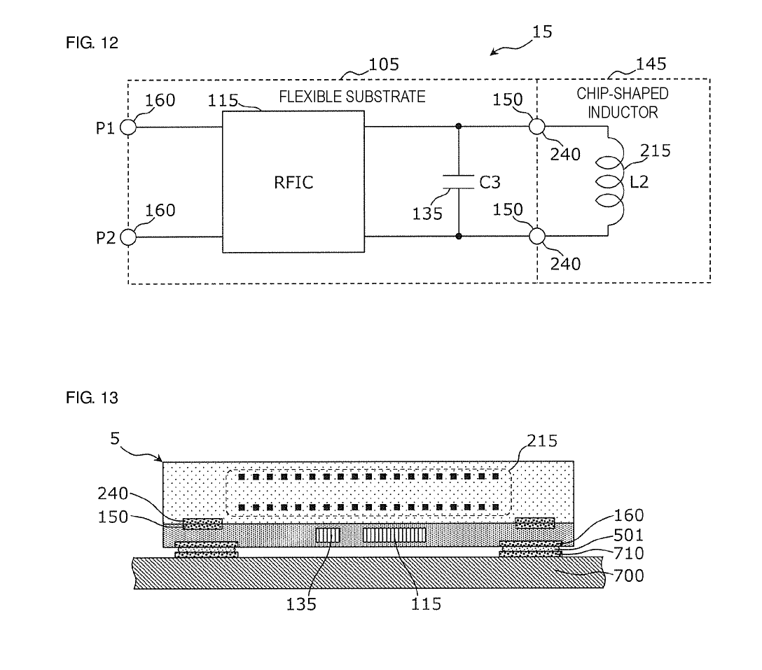

FIG. 12 is a circuit diagram of an example of a RF circuit that is provided in the RF module 5.

A RF circuit 15 illustrated in FIG. 12 includes a RFIC, an antenna coil L2, a capacitor C3 and input and output terminals P1 and P2.

The RFIC and the capacitor C3 are defined by the RFIC element 115 and the chip capacitor 135 that are included in the flexible substrate 105. The antenna coil L2 is defined by the coil 215 that is included in the chip inductor 145. The signal terminals P1 and P2 are defined by the input and output terminals 160 that are disposed on the flexible substrate 105. The antenna coil L2 is connected to the RFIC with the connection terminals 150 and 240 interposed therebetween.

The antenna coil L2 and the capacitor C3 are connected in parallel to a pair of output terminals of the RFIC and define an antenna resonant circuit.

The RFIC includes a power amplifier and a low-noise amplifier, amplifies a high-frequency signal that the signal terminals P1 and P2 receive using the power amplifier, and emits the signal from the antenna coil L2. A high-frequency signal that the antenna coil L2 receives is amplified by the low-noise amplifier and output from the signal terminals P1 and P2.

The RFIC may preferably be, for example, an IC for NFC (near field communication) but is not limited thereto. In this case, the RF module 5 defines a wireless communication module for NFC in which the antenna coil and a control IC are integrally provided. The NFC described herein means a communication standard, which is represented by a RF tag, for communication in a range of several centimeters to about 1 meter with small electric power, for example.

The RF module 5 is not limited to NFC and may be a wireless communication module that communicates in accordance with a communication standard, such as Bluetooth (registered trademark), Zigbee (registered trademark), or a wireless LAN (Local Area Network), for example.

FIG. 13 is a sectional view of an example of a structure in which the RF module 5 is mounted when a section XIII-XIII in FIG. 11 is viewed from the direction of arrows. FIG. 13 illustrates, together with the RF module 5, a substrate 700 on which the RF module 5 is mounted.

The substrate 700 is a motherboard, such as a printed circuit board, for example. Connection patterns 710 are disposed on one main surface of the substrate 700 at positions that correspond to the input and output terminals 160 of the RF module 5. The input and output terminals 160 and the connection patterns 710 are connected to each other using a conductive joining material 501. Consequently, the RF module 5 is mounted on the substrate 700. An example of the conductive joining material 501 is tin-based solder, for example, and the RF module 5 may be mounted on the substrate 700 by a reflow process, for example. The RF module 5 is used as a wireless communication module by an application circuit on the substrate 700.

The specific examples of the RF module 5 and the RF circuit 15 are described above. The RF module 5 achieves the same or substantially the same advantageous effects as the DC/DC converter module 1 described above.

More specifically, since the flexible substrate 105 includes a thermoplastic resin, that is, the substrate has shock absorption properties, the RFIC element 115 is unlikely to directly take an impact, such as a falling impact, and the impact resistance is increased.

Since the flexible substrate 105 includes the chip capacitor 135, that is, only the chip inductor 145 is mounted on a surface of the substrate, the size of the chip inductor 145 is able to be increased as much as possible with respect the area of the substrate. This enables transmission and reception efficiency to be improved because of a large size of the antenna.

Since the coil 215 is disposed such that the central axis thereof is parallel or substantially parallel to the main surfaces of the RF module 5, the magnetic field of the coil 215 is unlikely to be affected by the RFIC element 115 and the chip capacitor 135 and an electrode pattern of the flexible substrate 105.

The RFIC element 115 is disposed so as not to overlap the input and output terminals 160 in a plan view. This avoids disposing the RFIC element 115 at a location of the flexible substrate 105 at which the shock absorption properties are decreased due to the input and output terminals 160, and further improves impact resistance against, for example, falling.

The connection terminals 150 are disposed at locations of the flexible substrate 105 at which the connection terminals 150 overlap the input and output terminals 160 in a plan view. An interlayer conductor may be disposed at one of locations at which the connection terminals 150 and the input and output terminals 160 overlap. This makes the stress that is applied to the input and output terminals 160 unlikely to be applied to the RFIC element 115 and further increases the mechanical strength of the RF module 5.

Although the DC/DC converter modules according to the preferred embodiments of the present invention are described above, the present invention is not limited to the preferred embodiments. Preferred embodiments obtained by modifying the above-described preferred embodiments by a person skilled in the art, and preferred embodiments obtained by combining features of the preferred embodiments may be within the range of one or more preferred embodiments of the present invention without departing from the spirit of the present invention.

For example, the chip inductor 141, the body 200 of which is directly joined to the flexible substrate 101, which is described according to the second preferred embodiment, may be provided with the structure that decreases a noise that is made by the switching IC element 110, which is described according to the third preferred embodiment.

Preferred embodiments of the present invention may be widely used as DC/DC converter modules for electronic devices, such as a personal digital assistant and a digital camera, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inductor module comprising:
an insulating flexible substrate including a thermoplastic resin;
an IC element that is included in the flexible substrate;
a chip capacitor that is included in the flexible substrate;
a chip inductor that includes a magnetic-material body and that is mounted on a first main surface of the flexible substrate; and
input and output terminals disposed on a second main surface of the flexible substrate.

2. The inductor module according to claim 1, wherein the IC element is within a projection area of the chip inductor in a plan view.

3. The inductor module according to claim 1, wherein the chip inductor includes a planar electrode on a main surface thereof that faces the flexible substrate and is connected to the flexible substrate with the planar electrode interposed therebetween.

4. The inductor module according to claim 1, wherein the IC element is disposed so as not to overlap the input and output terminals in a plan view.

5. The inductor module according to claim 1, wherein portions of wiring lines that connect the IC element and the input and output terminals to each other extend to an inside of the body of the chip inductor.

6. The inductor module according to claim 1, wherein the body of the chip inductor includes magnetic ceramics.

7. The inductor module according to claim 1, wherein the body of the chip inductor and the flexible substrate are directly joined to each other.

8. The inductor module according to claim 1, wherein an auxiliary layer is disposed on a main surface of the chip inductor opposite to the flexible substrate.

9. The inductor module according to claim 1, wherein the chip inductor and the flexible substrate have a same or substantially a same size in a plan view.

10. The inductor module according to claim 1, wherein the IC element is a switching IC element, the chip inductor is a choke coil, and the inductor module is a DC/DC converter module.

11. The inductor module according to claim 1, wherein the IC element is a RFIC element, the chip inductor is an antenna coil, and the inductor module is a RF module.

12. The inductor module according to claim 1, wherein the flexible substrate and the chip inductor are connected to each other at connection terminals.

13. The inductor module according to claim 12, wherein the connection terminals are Land Grid Array planar electrodes.

14. The inductor module according to claim 1, wherein the chip inductor includes magnetic-material layers that are stacked.

15. The inductor module according to claim 14, wherein the chip inductor includes coil conductors that define a coil.

16. The inductor module according to claim 15, wherein the coil conductors include in-plane conductors that loop along main surfaces of the magnetic-material layers and interlayer conductors that extend in a thickness direction of the magnetic-material layers.

17. The inductor module according to claim 16, wherein the in-plane conductors and the interlayer conductors are made of a metal including silver or an alloy of silver as a main component.

18. The inductor module according to claim 1, wherein the flexible substrate is a multilayer substrate that includes thermoplastic resin layers that are stacked.
